(19) United States
(12) Patent Application Publication
(10) Pub. No.: US 2009/0141716 A1
(43) Pub. Date: Jun. 4, 2009

(54) METHOD AND APPARATUS FOR PACKET RULE MATCHING

(75) Inventor: Limin Chang, Hangzhou City (CN)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: HANGZHOU H3C TECHNOLOGIES CO., LTD., Hangzhou City (CN)

(21) Appl. No.: 12/345,834

(22) Filed: Dec. 30, 2008

Related U.S. Application Data
(63) Continuation of application No. PCT/CN2008/071624, filed on Jul. 11, 2008.

(30) Foreign Application Priority Data
Nov. 30, 2007 (CN) 200710178449.7

(51) Int. Cl. H04L 12/56

(52) U.S. Cl. 370/389

(57) ABSTRACT

This invention discloses method and apparatus for packet rule matching. The method includes: creating multiple levels of storage tables, storage table other than final-level storage table records corresponding relation between value index and value range number, and final-level storage table records corresponding relation between packet rule number and combination index formed by value range number; upon receiving packet, searching first-level storage table for value index corresponding to value of quintuple of the packet; searching next-level storage table according to value range number corresponding to found value index until penultimate-level storage table; searching final-level storage table for combination index identical to combination value formed by the value range number found in the penultimate-level storage table, and obtaining packet rule number corresponding to the found combination value; and taking packet rule corresponding to the obtained packet rule number as matched packet rule. This invention can increase the speed of packet rule matching.

### FIELD OF THE INVENTION

The present invention relates to network communication technologies, and more particularly, to a method and apparatus for packet rule matching.

### BACKGROUND OF THE INVENTION

In a network, a particular packet usually needs particular processing, and therefore, a packet rule should be configured in a network device. In the packet rule, a corresponding relation between packet characteristic information and a processing action is defined. Upon receiving a packet, the network device performs packet rule matching according to packet characteristic information contained in the packet, and processes the packet according to a matched packet rule.

Currently, the packet characteristic information used during the definition of a packet rule is quintuple of the packet generally, including a source Internet Protocol (IP) address, a destination IP address, a protocol type, a source port number and a destination port number. Table 1 shows a conventional manner for storing packet rules. As shown in Table 1, the numeral following the symbol “/” in IP address X/X indicates the number of bits of a mask. For example, in the destination IP address 2.2.2.0/24 of a packet rule 1 in Table 1, the numeral 24 following the symbol “/” indicates that the mask has 24 bits, i.e. only 24 bits are compared while the rest bits are not compared.

TABLE 1

| | | | | Source | | |
|---|---|---|---|---|---|---|
| Packet rule | Source IP | Destination | Protocol | port | Destination | Processing |
| number | address | IP address | type | number | port number | action |
| 1 | 1.1.1.1/32 | 2.2.2.0/24 | Any | Any | Any | Pass |
| | | | (0-255) | (0-65535) | (0-65535) | |
| 2 | 1.1.1.0/24 | 2.2.2.0/24 | 6 | Any | 80 | Pass |
| | | | | (0-65535) | | |
| 3 | Any | 2.2.2.1/32 | 6 | Any | 80 | Pass |
| | (0.0.0.0/0) | | | (0-65535) | | |
| 4 | Any | Any | Any | Any | Any | Not Pass |
| | (0.0.0.0/0) | (0.0.0.0/0) | (0-255) | (0-65535) | (0-65535) | |

In the prior art, by the packet rule table shown in Table 1, the network device retrieves the quintuple from the packet upon receiving the packet, traverses all packet rules in Table 1 and matches the retrieved quintuple with the quintuple of each packet rule in Table 1. If the matching succeeds, the network device processes the packet according to the processing action defined in the matched packet rule, e.g., forwards the packet if the processing action is “Pass” or discards the packet if the processing action is “Not Pass”. That the matching succeeds means the quintuple retrieved from the packet is in the range of the quintuple defined in the packet rule. For example, the quintuple of a packet 1 includes 1.1.1.1, 2.2.2.1, 6, 1024 and 23, which are in the range of the quintuple corresponding to the packet rule 1 respectively, and therefore, the processing action for the packet 1 is “Pass” defined in the packet rule 1; the quintuple of a packet 2 includes 1.1.1.2, 2.2.2.1, 6, 1024 and 80, which are out of the range of the quintuple corresponding to the packet rule 1 but are respectively in the range of the quintuple corresponding to the packet rule 2 instead, and therefore, the processing action for the packet 2 is “Pass” defined in the packet rule 2; the quintuple of a packet 3 includes 3.1.1.2, 2.2.2.1, 6, 1024 and 80, which are out of the range of the quintuple corresponding to the packet rule 1 or 2 but are respectively in the range of the quintuple corresponding to the packet rule 3 instead, and therefore, the processing action for the packet 3 is “Pass” defined in the packet rule 3; the quintuple of a packet 4 includes 3.1.1.2, 2.2.2.1, 6, 1024 and 23, which are out of the range of the quintuple corresponding to the packet rule 1, 2 or 3 but are respectively in the range of the quintuple corresponding to the packet rule 4 instead, and therefore, the processing action for the packet 4 is “Not Pass” defined in the packet rule 4.

As can be seen from the above, when the packet rule matching is performed in the prior art, the matching needs to be performed for every packet rule one by one according to a sequence from top to end until the matching succeeds. At this point, if there are large numbers of packet rules in a network, the matching can not succeed until longer time is taken to perform the matching for the large numbers of the packet rules. Thereby, the speed of the packet rule matching is decreased greatly and the performance of the network device is also decreased.

In the prior art, because the matching is performed for all the packet rules in turn, in the case of performing the packet rule matching for a packet containing one type of quintuple, the matching may succeed after the matching is performed for only a few packet rules; while in the case of performing the packet rule matching for a packet containing another type of quintuple, the matching may succeed after the matching is performed for large numbers of packet rules. Therefore, the time for the network device to perform the packet rule matching for different packets differs greatly, which causes network jitter and volatility. For example, if the time for the network device to perform the packet rule matching for different packets differs greatly, other devices which receive the packet sent by the network device can not determine appropriate time for waiting to receive the packet, which is not beneficial to the stability of network performance.

### SUMMARY OF THE INVENTION

The present invention provides a method for packet rule matching and an apparatus for packet rule matching, so as to make the speed of the packet rule matching increase.

A method of packet rule matching includes:

creating multiple levels of storage tables, wherein a storage table other than a final-level storage table records a corresponding relation between a value index and a value range number, and the final-level storage table records a corresponding relation between a packet rule number and a combination index formed by the value range number;

upon receiving a packet, searching a first-level storage table for a value index corresponding to a value of quintuple of the packet; searching a next-level storage table according to a value range number corresponding to the found value index until a penultimate-level storage table; searching a final-level storage table for a combination index identical to a combination value formed by the value range number found in the penultimate-level storage table, and obtaining a packet rule number corresponding to the found combination value; and

taking a packet rule corresponding to the obtained packet rule number as a matched packet rule.

An apparatus of packet rule matching includes:

a multi-level storage table creation unit, adapted to create and store multiple levels of storage tables, wherein a storage table other than a final-level storage table records a corresponding relation between a value index and a value range number, and the final-level storage table records a corresponding relation between a packet rule number and a combination index formed by the value range number;

a packet matching performing unit, adapted to search a first-level storage table stored in the multi-level storage table creation unit for a value index corresponding to a value of quintuple of a packet upon receiving the packet, search a next-level storage table stored in the multi-level storage table creation unit according to a value range number corresponding to the found value index until a penultimate-level storage table; search a final-level storage table stored in the multi-level storage table creation unit for a combination index identical to a combination value formed by the value range number found in the penultimate-level storage table, and obtain a packet rule number corresponding to the found combination value; take a packet rule corresponding to the obtained packet rule number as a matched packet rule.

A method for packet rule matching includes:

receiving a packet from a network and determining one or more value indexes of one or more blocks of the packet; wherein a same value index is assigned to different values if the different values of a block correspond a common matching result or a common set matching results;

searching a matching table to get a matching result, wherein the matching table comprise at least one value index of at least one block and corresponding matching result.

As can be seen, the present invention has the following advantages:

Firstly, in the present invention, multiple levels of storage tables are created according to an original packet rule table, and each level of storage tables only include corresponding relations between the indexes and the value range numbers or between the indexes and the packet rule numbers. Thus, after receiving the packet, the network device only needs to search the multiple levels of the storage tables instead of searching the original packet rule table. Therefore, in the case that there are large numbers of packet rules in the original packet rule table, the time for finding a matched packet rule by searching the multiple levels of the storage tables is greatly reduced, the speed of the packet rule matching is therefore increased greatly and the processing performance of the network device is increased.

Secondly, in the present invention, when the packet rule matching is performed for any packet, the times of the packet rule matching only depends on the created multiple levels of the storage tables. Because the number of the multiple levels of the storage tables is fixed, the times of the packet rule matching for one packet is equal to that for another packet. For example, after seven first-level storage tables and one second-level storage table are created, eight times of the packet rule matching needs to be performed for any packet and the times of the packet rule matching for one packet is the same as that for another packet. Therefore, the time for the network device to perform packet rule matching for different packets becomes nearly the same, and the network jitter and volatility in the prior art are thus avoided, which is beneficial for performing various QoS processing in the network. Because the time for the network device to perform the packet rule matching for different packets is nearly the same, fixed and appropriate time for waiting to receive a packet may be determined in other devices which receive the packet from the network device, and the network performance is therefore increased.

### BRIEF DESCRIPTION OF THE DRAWINGS

FIG. 1 is a flowchart illustrating packet rule matching in accordance with a first embodiment of the present invention.

FIG. 2 is a flowchart illustrating packet rule matching in accordance with a second embodiment of the present invention.

FIG. 3 is a schematic diagram illustrating an apparatus for packet rule matching in accordance with an embodiment of the present invention.

### DETAILED DESCRIPTION OF THE INVENTION

The present invention is hereinafter described in detail with reference to the accompanying drawings and embodiments so as to make the objective, technical solution and merits of the present invention more apparent.

The present invention provides a method for packet rule matching. The method includes: creating multiple levels of storage tables, where storage tables other than a final-level storage table respectively record corresponding relations between value indexes and value range numbers, and the final-level storage table records corresponding relations between packet rule numbers and combination indexes formed by the value range numbers; upon receiving a packet, searching for a value of the quintuple in the packet from the value indexes in a first-level storage table, searching a next-level storage table according to a value range number corresponding to the found value index until a penultimate-level storage table, and searching for a combination value formed by the value range numbers found in the penultimate-level storage table from the combination indexes in the final-level storage table, and obtaining a packet rule number corresponding to the combination value found from the final-level storage table; taking the packet rule corresponding to the obtained packet rule number as a matched packet rule.

The multiple levels of the storage tables created in this invention may be two or three or even more levels of the storage tables.

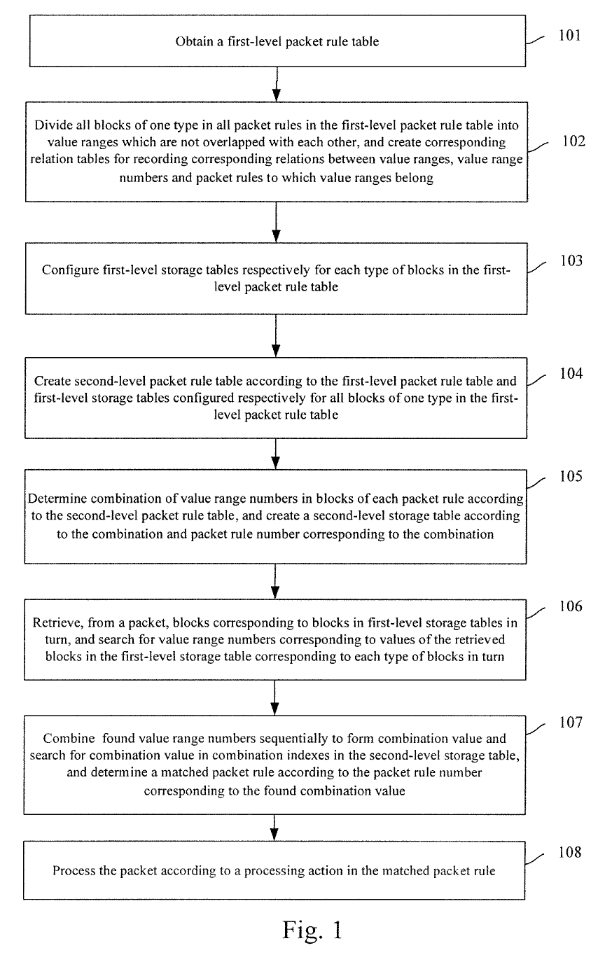

FIG. 1 is a flowchart illustrating packet rule matching in accordance with a first embodiment of the present invention. As shown in FIG. 1, in the embodiment of the present invention, supposing that two levels of the storage tables are created based on the original packet rule table shown in Table 1, the process of the packet rule matching includes the following.

Block 101: A first-level packet rule table is obtained by dividing each element of quintuple of each packet rule in the original packet rule table into blocks with designated bits.

Herein, the quintuple includes five elements: a source IP address, a destination P address, a protocol type, a source port number and a destination port number. The source IP address and the destination IP address respectively have 32 bits, the protocol type has 8 bits, and the source port number and the destination port number respectively have 16 bits. Therefore, in Block 101, a preferred processing manner for dividing each element of the quintuple of each packet rule into the blocks is: dividing the source IP address into two blocks, one of which includes the higher 16 bits of the source IP address and the other of which includes the lower 16 bits of source IP address; dividing the destination IP address into tow blocks, one of which includes the higher 16 bits of the destination IP address and the other of which includes the lower 16 bits of destination IP address; taking the protocol type as one block including 8 bits of the protocol type; taking the source port number as one block including 16 bits of the source port number; and taking the destination port number as one block including 16 bits of the destination port number. In other words, there are seven blocks all together. Thus, after the original packet rule table shown in Table 1 is processed in this Block, the first-level packet rule table shown in Table 2 is obtained.

TABLE 2
First-level packet rule table

| | | | Higher 16 | Lower 16 | | | | |
|---|---|---|---|---|---|---|---|---|
| | Higher 16 | Lower 16 | bits of | bits of | | | | |
| Packet | bits of | bits of | destination | destination | | Source | Destination | |
| rule | source IP | source IP | IP | IP | Protocol | port | port | Processing |
| number | address | address | address | address | type | number | number | action |
| 1 | 1.1/16 | 1.1/16 | 2.2/16 | 2.0/8 | Any | Any | Any | Pass |
| | | | | | (0-255) | (0-65535) | (0-65535) | |
| 2 | 1.1/16 | 1.0/8 | 2.2/16 | 2.0/8 | 6 | Any | 80 | Pass |
| | | | | | | (0-65535) | | |
| 3 | 0.0/0 | 0.0/0 | 2.2/16 | 2.1/16 | 6 | Any | 80 | Pass |
| | | | | | | (0-65535) | | |
| 4 | 0.0/0 | 0.0/0 | 0.0/0 | 0.0/0 | Any | Any | Any | Not |
| | | | | | (0-255) | (0-65535) | (0-65535) | Pass |

Certainly, in this Block, the manner of dividing the quintuple of each packet rule into seven blocks as shown in the first-level packet rule table of Table 2 is just a preferred manner. In actual service applications, other first-level packet rule tables different from Table 2 may be created, in other words, the quintuple may be divided into multiple blocks including other bits. For example, when the quintuple is divided into blocks, the source IP address with 32 bits and destination IP address with 32 bits are respectively divided into four blocks each of which includes 8 bits, the protocol type is taken as one block including 8 bits, and both the source port number with 16 bits and the destination port number with 16 bits are respectively divided into two blocks each of which includes 8 bits. Thereby, a first-level packet rule table including thirteen blocks all together is created.

In the following process, the embodiment will be described with reference to the example that the quintuple of each packet rule is divided into seven blocks as shown in the first-level packet rule table of Table 2.

Block 102: All blocks of one type in all packet rules in the first-level packet rule table are divided into value ranges which are not overlapped with each other, and a corresponding relation table is created for recording corresponding relations between the value ranges, the value range numbers and the packet rules to which the value ranges belong.

In this Block, the blocks of one type refer to the blocks with the same name in different packet rules. For example, referring to Table 2, four blocks of the higher 16 bits of the source IP address in four packet rules are the blocks of one type, and four blocks of the higher 16 bits of the destination IP address in four packet rules are the blocks of one type.

First, the blocks of one type in the first-level packet rule table, i.e. the higher 16 bits of the source IP address, are described.

In the first-level packet rule table, the higher 16 bits of the source IP address in the packet rules 1 to 4 are 1.1/16, 1.1/16, 0.0/0 and 0.0/0 respectively, where the numeral following the symbol “/” indicates the number of bits of a mask.

Hexadecimal transformation is performed for the higher 16 bits of the source IP address in each of the packet rules 1 to 4, and hexadecimal numerals after the hexadecimal transformation are 0x0101, 0x0101, 0x0000-0xffff and 0x0000-0xffff respectively. According to a value range of each block of the higher 16 bits of the source IP address in the first-level packet rule table, the hexadecimal numerals after the hexadecimal transformation are divided into hexadecimal value ranges which are not overlapped with each other, such as 0x0000-0x0100, 0x0101 and 0x0102-0xffff. A corresponding relation table is created for recording corresponding relations between the value ranges, the value range numbers and the packet rules to which the value ranges belong. With respect to the value range 0x0000-0x0100, because it is in a range indicated by the higher 16 bits of the source IP addresses 0.0/0 and 0.0/0 in the packet rules 3 and 4, the packet rules to which the value range 0x0000-0x0100 belongs are the packet rules 3 and 4. With respect to the value range 0x0101, because it is in a range indicated by the higher 16 bits of the source IP addresses in the packet rules 1, 2, 3 and 4, the packet rules to which the value range 0x0101 belongs are the packet rules 1, 2, 3 and 4. With respect to the value range 0x0102-0xffff, because it is in a range indicated by the higher 16 bits of the source IP addresses in the packet rules 3 and 4, the packet rules to which the value range 0x0102-0xffff belongs are the packet rules 3 and 4. Therefore, with respect to the higher 16 bits of the source IP address in the first-level packet rule table, the corresponding relation table for recording the corresponding relations between the value ranges, the value range numbers and the packet rules to which the value ranges belong may be shown in Table 3 below.

TABLE 3
Corresponding relation table of higher 16 bits of source IP address

| | | Packet rule to which |
|---|---|---|
| Value range | Value range number | value range belongs |
| 0x0000-0x0100 | 0 | 3, 4 |
| 0x0101 | 1 | 1, 2, 3, 4 |
| 0x0102-0xffff | 0 | 3, 4 |

It should be noted that, as shown in Table 3, because the value ranges 0x0000-0x0100 and 0x0102-0xffff correspond to the same packet rules, i.e. the packet rules 3 and 4, the same value range number is defined for the two value ranges.

Second, the blocks of one type in the first-level packet rule table, i.e. the lower 16 bits of the source IP address, are described.

In the first-level packet rule table, the lower 16 bits of the source IP address in the packet rules 1 to 4 are 1.1/16, 1.0/8, 0.0/0 and 0.0/0 respectively, where the numeral following the symbol “/” indicates the number of bits of a mask.

The hexadecimal transformation is performed for the lower 16 bits of the source IP address in each of the packet rules 1 to 4, and hexadecimal numerals after the hexadecimal transformation are 0x0101, 0x0100-0x01ff, 0x0000-0xffff and 0x0000-0xffff respectively. According to a value range of each block of the lower 16 bits of the source IP address in the first-level packet rule table, the hexadecimal numerals after the hexadecimal transformation are divided into hexadecimal value ranges which are not overlapped with each other, such as 0x0000-0x00ff, 0x01000, 0x0101, 0x0102-0x01ff and 0x0200-0xffff. A corresponding relation table is created for recording corresponding relations between the value ranges, the value range numbers and the packet rules to which the value ranges belong. With respect to the value range 0x0000-0x00ff, because it is in a range indicated by the lower 16 bits of the source IP addresses 0.0/0 and 0.0/0 in the packet rules 3 and 4, the packet rules to which the value range 0x0000-0x00ff belongs are the packet rules 3 and 4. With respect to the value range 0x0100, because it is in a range indicated by the lower 16 bits of the source IP addresses in the packet rules 2, 3 and 4, the packet rules to which the value range 0x0100 belongs are the packet rules 2, 3 and 4. With respect to the value range 0x0101, because it is in a range indicated by the lower 16 bits of the source IP addresses in the packet rules 1, 2, 3 and 4, the packet rules to which the value range 0x0101 belongs are the packet rules 1, 2, 3 and 4. With respect to the value range 0x0102-0x01ff, because it is in a range indicated by the lower 16 bits of the source IP addresses in the packet rules 2, 3 and 4, the packet rules to which the value range 0x0102-0x01ff belongs are the packet rules 2, 3 and 4. With respect to the value range 0x0200-0xffff, because it is in a range indicated by the lower 16 bits of the source IP addresses in the packet rules 3 and 4, the packet rules to which the value range 0x0200-0xffff belongs are the packet rules 3 and 4. Therefore, with respect to the lower 16 bits of the source IP address in the first-level packet rule table, the corresponding relation table for recording the corresponding relations between the value ranges, the value range numbers and the packet rules to which the value ranges belong may be shown in Table 4 below.

TABLE 4
Corresponding relation table of lower 16 bits of source IP address

| | | Packet rule to which |
|---|---|---|
| Value range | Value range number | value range belongs |
| 0x0000-0x00ff | 0 | 3, 4 |
| 0x0100 | 1 | 2, 3, 4 |
| 0x0101 | 2 | 1, 2, 3, 4 |
| 0x0102-0x01ff | 1 | 2, 3, 4 |
| 0x0200-0xffff | 0 | 3, 4 |

It should be noted that, as shown in Table 4, because the value ranges 0x0000-0x00ff and 0x0200-0xffff correspond to the same packet rules, i.e. the packet rules 3 and 4, the same value range number 0 is defined for the two value ranges; because the value ranges 0x0100 and 0x0102-0x01ff correspond to the same packet rules, i.e. the packet rules 2, 3 and 4, the same value range number 1 is defined for the two value ranges.

After the above, corresponding relation tables for recording the corresponding relations between the value ranges, value range numbers and the packet rules to which the value ranges belong are created respectively for the blocks of one type corresponding to the higher 16 bits of the source IP address in the first-level packet rule table and the blocks of one type corresponding to the lower 16 bits of the source IP address in the first-level packet rule table.

Third, according to a process similar to that for the higher 16 bits of the source IP address and the lower 16 bits of the source IP address, the hexadecimal transformation is performed respectively for the blocks of one type in the packet rules 1 to 4, i.e. the higher 16 bits of the destination IP address. The hexadecimal numerals after the hexadecimal transformation are divided into hexadecimal value ranges which are not overlapped with each other, and a corresponding relation table is created for recording the corresponding relations between the value ranges, the value range numbers and the packet rules to which the value ranges belong. The corresponding relation table is shown in Table 5.

TABLE 5
Corresponding relation table of higher 16 bits of destination IP address

| | | Packet rule to which |
|---|---|---|
| Value range | Value range number | value range belongs |
| 0x0000-0x0201 | 0 | 4 |
| 0x0202 | 1 | 1, 2, 3, 4 |
| 0x0203-0xffff | 0 | 4 |

Fourth, the hexadecimal transformation is performed respectively for the blocks of one type in the packet rules 1 to 4 in the first-level packet rule table, i.e. the lower 16 bits of the destination IP address. The hexadecimal numerals after the hexadecimal transformation are divided into hexadecimal value ranges which are not overlapped with each other, and a corresponding relation table is created for recording the corresponding relations between the value ranges, the value range numbers and the packet rules to which the value ranges belong. The corresponding relation table is shown in Table 6 below.

TABLE 6
Corresponding relation table of lower 16 bits of destination IP address

| | | Packet rule to which |
|---|---|---|
| Value range | Value range number | value range belongs |
| 0x0000-0x01ff | 0 | 4 |
| 0x0200 | 1 | 1, 2, 4 |
| 0x0201 | 2 | 1, 2, 3, 4 |
| 0x0202-0x02ff | 1 | 1, 2, 4 |
| 0x0300-0xffff | 0 | 4 |

Fifth, according to a process similar to that for the higher 16 bits of the source IP address and the lower 16 bits of the source IP address, the hexadecimal transformation is performed respectively for the blocks of one type in the packet rules 1 to 4 in the first-level packet rule table, i.e. the source port number. The hexadecimal numerals after the hexadecimal transformation are divided into hexadecimal value ranges which are not overlapped with each other, and a corresponding relation table is created for recording the corresponding relations between the value ranges, the value range numbers and the packet rules to which the value ranges belong. The corresponding relation table is shown in Table 7 below.

TABLE 7
Corresponding relation table of source port number

| | | Packet rule to which |
|---|---|---|
| Value range | Value range number | value range belongs |
| 0x0000-0xffff | 0 | 1, 2, 3, 4 |

Sixth, according to a process similar to that for the higher 16 bits of the source IP address and the lower 16 bits of the source IP address, the hexadecimal transformation is performed respectively for the blocks of one type in the packet rules 1 to 4 in the first-level packet rule table, i.e. the destination port number. The hexadecimal numerals after the hexadecimal transformation are divided into hexadecimal value ranges which are not overlapped with each other, and a corresponding relation table is created for recording the corresponding relations between the value ranges, the value range numbers and the packet rules to which the value ranges belong. The corresponding relation table is shown in Table 8 below.

TABLE 8
Corresponding relation table of destination port number

| | | Packet rule to which |
|---|---|---|
| Value range | Value range number | value range belongs |
| 0x0000-0x004f | 0 | 1, 4 |
| 0x0050 | 1 | 1, 2, 3, 4 |
| 0x0051-0xffff | 0 | 1, 4 |

Seventh, according to a process similar to that for the higher 16 bits of the source IP address and the lower 16 bits of the source IP address, the hexadecimal transformation is performed respectively for the blocks of one type in the packet rules 1 to 4 in the first-level packet rule table, i.e. the protocol type. The hexadecimal numerals after the hexadecimal transformation are divided into hexadecimal value ranges which are not overlapped with each other, and a corresponding relation table is created for recording the corresponding relations between the value ranges, the value range numbers and the packet rules to which the value ranges belong. The corresponding relation table is shown in Table 9 below.

TABLE 9
Corresponding relation table of protocol type

| | | Packet rule to which |
|---|---|---|
| Value range | Value range number | value range belongs |
| 0x00-0x05 | 0 | 1, 4 |
| 0x06 | 1 | 1, 2, 3, 4 |
| 0x07-0xff | 0 | 1, 4 |

Block 103: According to the corresponding relation tables created respectively for each type of the blocks in the first-level packet rule table, first-level storage tables are configured respectively for each type of the blocks in the first-level packet rule table.

The first-level storage table may be designed as including a value index and a value range number corresponding to the value index.

In this Block, the process of configuring the first-level storage table corresponding to each type of the blocks in the quintuple of all the packet rules includes: taking, in turn, all values in a value range from the minimum numeral to the maximum value among all the blocks of one type in the first packet rule table as value indexes in the first-level storage table, and determining a value range number corresponding to each value index in the first-level storage table according to the value range number corresponding to each value range in the corresponding relation table of all the blocks of one type.

The implementation of this Block is described hereinafter according to specific examples.

In the first-level packet rule table, the higher 16 bits of all source IP addresses are the blocks of one type, and the corresponding relation table created for this type of the blocks for recording the corresponding relations between the value ranges, the value range numbers and the packet rules to which the value ranges belong is shown in Table 3 above. Therefore, the first-level storage table configured according to this corresponding relation table may refer to Table 10 below.

TABLE 10
First-level storage table of higher 16 bits of source IP address

| Value index (hexadecimal) | Value range number |
|---|---|
| 0x0000 | 0 |
| . . . | 0 |
| 0x0100 | 0 |
| 0x0101 | 1 |
| 0x0102 | 0 |
| . . . | 0 |
| 0xffff | 0 |

Herein, with reference to Table 3 and Table 10, because the value ranges of the higher 16 bits of the source IP address in the corresponding relation table shown in Table 3 are hexadecimal, the value indexes in Table 10 are from the minimum hexadecimal value 0x0000 to the maximum hexadecimal value 0xffff, and the value range numbers corresponding to the value indexes respectively are recorded in turn in the first-level storage table shown in Table 10 according to the corresponding relations between the value ranges and the value range numbers in Table 3. For example, in Table 3, the value range 0x0000-0x0100 corresponds to the value range number 0, and therefore, each of the value indexes from 0x0000 to 0x0100 corresponds to the value range number 0 in Table 10. For another example, in Table 3, the value range 0x0101 corresponds to the value range number 1, and therefore, the value index 0x0101 corresponds to the value range number 1 in Table 10.

Similarly, the lower 16 bits of all source IP addresses in the first-level packet rule table are the blocks of one type, and the corresponding relation table created for this type of the blocks for recording the corresponding relations between the value ranges, the value range numbers and the packet rules to which the value ranges belong is shown in Table 4 above. Therefore, the first-level storage table configured according to this corresponding relation table may refer to Table 11 below.

TABLE 11
First-level storage table of lower 16 bits of source IP address

| Value index (hexadecimal) | Value range number |
|---|---|
| 0x0000 | 0 |
| . . . | 0 |
| 0x00ff | 0 |
| 0x0100 | 1 |
| 0x0101 | 2 |
| 0x0102 | 1 |
| . . . | 1 |
| 0x01ff | 1 |
| 0x0200 | 0 |
| . . . | 0 |
| 0xffff | 0 |

Similarly, the higher 16 bits of all destination IP addresses in the first-level packet rule table are the blocks of one type, and the corresponding relation table created for this type of blocks for recording the corresponding relations between the value ranges, the value range numbers and the packet rules to which the value ranges belong is shown in Table 5 above. Therefore, the first-level storage table configured according to this corresponding relation table may refer to Table 12 below.

TABLE 12
First-level storage table of higher 16 bits of destination IP address

| Value index (hexadecimal) | Value range number |
|---|---|
| 0x0000 | 0 |
| . . . | 0 |
| 0x0201 | 0 |
| 0x0202 | 1 |
| 0x0203 | 0 |
| . . . | 0 |
| 0xffff | 0 |

Similarly, the lower 16 bits of all destination IP addresses in the first-level packet rule table are the blocks of one type, and the corresponding relation table created for this type of the blocks for recording the corresponding relations between the value ranges, the value range numbers and the packet rules to which the value ranges belong is shown in Table 6 above. Therefore, the first-level storage table configured according to this corresponding relation table may refer to Table 13 below.

TABLE 13
First-level storage table of lower 16 bits of destination IP address

| Value index (hexadecimal) | Value range number |
|---|---|
| 0x0000 | 0 |
| . . . | 0 |
| 0x01ff | 0 |
| 0x0200 | 1 |
| 0x0201 | 2 |
| 0x0202 | 1 |
| . . . | 1 |
| 0x02ff | 1 |
| 0x0300 | 0 |
| . . . | 0 |
| 0xffff | 0 |

Similarly, all the source port numbers in the first-level packet rule table are the blocks of one type, and the corresponding relation table created for this type of the blocks for recording the corresponding relations between the value ranges, the value range numbers and the packet rules to which the value ranges belong is shown in Table 7 above. Therefore, the first-level storage table configured according to this corresponding relation table may refer to Table 14 below.

TABLE 14
First-level storage table of source port numbers

| Value index (hexadecimal) | Value range number |
|---|---|
| 0x0000 | 0 |
| . . . | 0 |
| 0xffff | 0 |

Similarly, all the destination port numbers in the first-level packet rule table are the blocks of one type, and the corresponding relation table created for this type of the blocks for recording the corresponding relations between the value ranges, the value range numbers and the packet rules to which the value ranges belong is shown in Table 8 above. Therefore, the first-level storage table configured according to this corresponding relation table may refer to Table 15 below.

TABLE 15
First-level storage table of destination port number

| Value index (hexadecimal) | Value range number |
|---|---|
| 0x0000 | 0 |
| . . . | 0 |
| 0x004f | 0 |
| 0x0050 | 1 |
| 0x0051 | 0 |
| . . . | 0 |
| 0xffff | 0 |

Similarly, all the protocol types in the first-level packet rule table are the blocks of one type, and the corresponding relation table created for this type of the blocks for recording the corresponding relations between the value ranges, the value range numbers and the packet rules to which the value ranges belong is shown in Table 9 above. Therefore, the first-level storage table configured according to this corresponding relation table may refer to Table 16 below.

TABLE 16
First-level storage table of protocol type

| Value index (hexadecimal) | Value range number |
|---|---|
| 0x00 | 0 |
| . . . | 0 |
| 0x05 | 0 |
| 0x06 | 1 |
| 0x07 | 0 |
| . . . | 0 |
| 0xff | 0 |

Block 104: A second-level packet rule table is generated according to the first-level packet rule table and the first-level storage tables configured respectively for all blocks of one type in the first-level packet rule table.

The process of generating the second-level packet rule table includes: replacing a value range of each block in the first-level packet rule table with a value range number corresponding to each value index in the value range in the first-level storage table configured for the type of the block.

Referring to Table 2 and Tables 10 to 16, the second-level packet rule table may be obtained as shown in Table 17 below.

TABLE 17
Second-level packet rule table

| | Higher | Lower | Higher | Lower | | | | |
|---|---|---|---|---|---|---|---|---|
| | 16 bits | 16 bits | 16 bits | 16 bits | | | | |
| | of | of | of | of | | | | |
| Packet | source | source | destination | destination | | Source | Destination | |
| rule | IP | IP | IP | IP | Protocol | port | port | Processing |
| number | address | address | address | address | type | number | number | action |
| 1 | 1 | 2 | 1 | 1, 2 | 0, 1 | 0 | 0, 1 | Pass |
| 2 | 1 | 1, 2 | 1 | 1, 2 | 1 | 0 | 1 | Pass |
| 3 | 0, 1 | 0, 1, 2 | 1 | 2 | 1 | 0 | 1 | Pass |
| 4 | 0, 1 | 0, 1, 2 | 0, 1 | 0, 1, 2 | 0, 1 | 0 | 0, 1 | Not pass |

Hereinafter, the process of generating the second-level packet rule table shown in Table 17 is explained by taking the replacement process of each block of the packet rule 1 in Table 17 as an example.

Above all, referring to the first-level packet rule table shown in Table 2, in the packet rule 1, the higher 16 bits of the source IP address are one block which is 1.1/16 originally, i.e. the value range is 0x0101; and the value range number 1 corresponding to the value range of the higher 16 bits of the source IP address in the packet rule 1 may be obtained by searching the first-level storage table of the higher 16 bits of the source IP address shown in Table 10 according to the value range 0x0101. Therefore, in the second-level packet rule table shown in Table 17, the obtained value range number 1 is written in the position of the higher 16 bits of the source IP address of the packet rule 1.

Referring to the first-level packet rule table shown in Table 2, in the packet rule 1, the lower 16 bits of the source IP address are one block which is 1.1/16 originally, i.e. the value range is 0x0101; and the value range number 2 corresponding to the value range of the lower 16 bits of the source IP address in the packet rule 1 may be obtained by searching the first-level storage table of the lower 16 bits of the source IP address shown in Table 11 according to the value range 0x0101. Therefore, in the second-level packet rule table shown in Table 17, the obtained value range number 2 is written in the position of the lower 16 bits of the source IP address of the packet rule 1.

Referring to the first-level packet rule table shown in Table 2, in the packet rule 1, the higher 16 bits of the destination IP address are one block which is 2.2/16 originally, i.e. the value range is 0x020; and the value range number 1 corresponding to the value range of the higher 16 bits of the destination IP address in the packet rule 1 may be obtained by searching the first-level storage table shown of the higher 16 bits of the destination IP address in Table 12 according to the value range 0x0202. Therefore, in the second-level packet rule table shown in Table 17, the obtained value range number 1 is written in the position of the higher 16 bits of the destination IP address of the packet rule 1.

Referring to the first-level packet rule table shown in Table 2, in the packet rule 1, the lower 16 bits of the destination IP address are one block which is 2.0/8 originally, i.e. the value range is 0x0200-0x02ff; and the value range numbers 1 and 2 corresponding to all the value indexes in the value range of the lower 16 bits of the destination IP address in the packet rule 1 may be obtained by searching the first-level storage table of the lower 16 bits of the destination IP address shown in Table 13 according to the value range 0x0200-0x02ff. Therefore, in the second-level packet rule table shown in Table 17, the obtained value range numbers 1 and 2 are written in the position of the lower 16 bits of the destination IP address of the packet rule 1.

Referring to the first-level packet rule table shown in Table 2, in the packet rule 1, the protocol type is one block and the value range is 0x00-0xff; and the value range numbers 1 and 2 corresponding to all the value indexes in the value range of the protocol type in the packet rule 1 may be obtained by searching the first-level storage table of the protocol type shown in Table 16 according to the value range 0x00-0xff. Therefore, in the second-level packet rule table shown in Table 17, the obtained value range numbers 0 and 1 are written in the position of the protocol type of the packet rule 1.

Referring to the first-level packet rule table shown in Table 2, in the packet rule 1, the source port number is one block and the value range is 0x0000-0xffff; and the value range number 0 corresponding to all the value indexes in the value range of the source port number in the packet rule 1 may be obtained by searching the first-level storage table of the source port number shown in Table 14 according to the value range 0x0000-0xffff. Therefore, in the second-level packet rule table shown in Table 17, the obtained value range number 0 is written in the position of the source port number of the packet rule 1.

Referring to the first-level packet rule table shown in Table 2, in the packet rule 1, the destination port number is one block and the value range is 0x0000-0xffff; and the value range numbers 0 and 1 corresponding to all the value indexes in the value range of the destination port number in the packet rule 1 may be obtained by searching the first-level storage table of the destination port number shown in Table 15 according to the value range 0x0000-0xffff. Therefore, in the second-level packet rule table shown in Table 17, the obtained value range numbers 0 and 1 are written in the position of the destination port number of the packet rule 1.

Block 105: A combination formed by the value range numbers of blocks of each packet rule is determined according to the second-level packet rule table, and a second-level storage table is generated according to the combination and the packet rule number corresponding to the combination.

The second-level storage table may include a combination index and a packet rule number corresponding to the combination index.

In this Block, the process of generating the second-level storage table includes: determining the number of bits of a combination according to the number of the blocks of each packet rule in the second-level packet rule table, taking all combination values in a range from the minimum combination numeral in the combination to the maximum combination numeral formed by the value range numbers of the blocks as combination indexes in the second-level storage table; and taking a packet rule number corresponding to the combination values formed by the value range numbers of the blocks of each packet rule in the second-level packet rule table as a packet rule number corresponding to the combination indexes in the second-level storage table. Therefore, the second-level storage table is obtained.

The second-level storage table created based on the second-level packet rule table shown in Table 17 may refer to Table 18 below.

TABLE 18
Second-level storage table

| Combination index (quaternary) | Packet rule number |
|---|---|
| 0000000 | 4 |
| . . . | |
| 0012101 | 3 |
| . . . | |
| 1111101 | 2 |
| . . . | |
| 1211000 | 1 |
| . . . | |
| 1212101 | 1 |

Referring to Tables 17 and 18, because the quintuple of each packet rule is divided into seven blocks in Table 17, the combination formed by the value range numbers of the seven blocks in each packet rule is a 7-bit combination. The minimum combination numeral is 0000000, and the maximum combination numeral formed by the value range numbers of the blocks is 1212101; and therefore, values of the combination indexes in Table 18 are from 0000000 to 1212101. For example, with respect to the value of the first combination index 0000000 in Table 18, it may be formed by the first value range numbers 0 respectively in the first block to the seventh block of the packet rule 4 in Table 17, i.e. respectively in the higher 16 bits of the source IP address, the lower 16 bits of the source IP address, the higher 16 bits of the destination IP address, the lower 16 bits of the destination IP address, the protocol type, the source port number and the destination port number; therefore, it may be determined that the value of the combination index 0000000 in Table 18 corresponds to the packet rule number 4. For another example, with respect to a value of the combination index 0012101 in Table 18, it may be formed by the first value range numbers respectively in the first block to the seventh block of the packet rule 3 in Table 17; therefore, it may be determined that the value of the combination index 0012101 in Table 18 corresponds to the packet rule number 3.

As can be concluded, in this Block, the sequence of forming a combination index in the second-level storage table is: the higher 16 bits of the source IP address, the lower 16 bits of the source IP address, destination IP address, the protocol type, the source port number and then the destination port number.

It should be noted that, in this Block, if a certain combination value in Table 18 corresponds to two or more than two packet rules, only a packet rule number with a highest priority level is recorded in the position of the packet rule number corresponding to the combination value in the second-level storage table of Table 18. Usually, the packet rule number with the highest priority level is a packet rule with a minimum packet rule number. For example, with respect to the seven blocks of the packet rule 1, the value range numbers 1, 2 and 1 are chosen respectively from the first three blocks, the second value range numbers 2 and 1 are chosen respectively from the fourth and fifth blocks, the value range number 0 is chosen from the sixth block, and the second value range number 1 of the seventh block is chosen; and therefore, the combination value 1212101 in Table 18 is obtained, i.e. the combination value 1212101 corresponds to the packet rule 1. However, according to an analysis of the packet rules 3 and 4, the value range numbers in the seven blocks of the packet rules 3 and 4 can also form the combination value 1212101, i.e. the combination value 1212101 also corresponds to the packet rules 3 and 4. According to the principle that one packet can match only one packet rule, only the packet rule number 1 which is the minimum packet rule number, i.e. with the highest priority level, is recorded in Table 18.

By far, seven first-level storage tables shown in Tables 10 to 16 and one second-level storage table shown in Table 18 are generated in the network device according to the original packet rule table shown in Table 1. In the subsequent process of the packet rule matching, seven first-level storage tables and one second-level storage table may be used directly for the matching, and the process of performing the matching includes Blocks 106 to 107 below.

Block 106: Upon receiving a packet, the network device retrieves, from the packet, blocks corresponding to the blocks divided in the first-level storage tables in turn; and searches the first-level storage tables respectively corresponding to each type of blocks in turn for value range numbers respectively corresponding to the value indexes of the retrieved blocks.

Because in the first-level packet rule table, each packet rule number corresponds to seven blocks, the implementation of this Block includes:

106A: The network device retrieves the first block from the received packet, i.e. the higher 16 bits of the source IP address, and searches the first-level storage table of the higher 16 bits of the source IP address for a value range number corresponding to the first block.

For example, the higher 16 bits of the source IP address retrieved from the packet are 0x0101, and the network device finds that the value range number corresponding to 0x0101 in the first-level storage table of the higher 16 bits of the source IP address shown in Table 10 is 1.

160B: The network device retrieves the second block from the received packet, i.e. the lower 16 bits of the source IP address, and searches the first-level storage table of the lower 16 bits of the source IP address for a value range number corresponding to the second block.

For example, the lower 16 bits of the source IP address retrieved from the packet are 0x0101, and the network device finds that the value range number corresponding to 0x0101 in the first-level storage table of the lower 16 bits of the source IP address shown in Table 11 is 2.

Block 160C: The network device retrieves the third block from the received packet, i.e. the higher 16 bits of the destination IP address, and searches the first-level storage table of the higher 16 bits of the destination IP address for a value range number corresponding to the third block.

For example, the higher 16 bits of the destination IP address retrieved from the packet are 0x0101, and the network device finds that the value range number corresponding to 0x0101 in the first-level storage table of the higher 16 bits of the destination IP address shown in Table 12 is 0.

Block 160D: The network device retrieves the fourth block from the received packet, i.e. the lower 16 bits of the destination IP address, and searches the first-level storage table of the lower 16 bits of the destination IP address for a value range number corresponding to the fourth block.

For example, the lower 16 bits of the destination IP address retrieved from the packet are 0x0202, and the network device finds that the value range number corresponding to 0x0202 in the first-level storage table of the lower 16 bits of the destination IP address shown in Table 13 is 1.

Block 160E: The network device retrieves the fifth block from the received packet, i.e. the protocol type, and searches the first-level storage table of the protocol type for a value range number corresponding to the fifth block. For example, the protocol type retrieved from the packet is 0x05, and the network device finds that the value range number corresponding to 0x05 in the first-level storage table of the protocol type shown in Table 16 is 0.

Block 160F: The network device retrieves the sixth block from the received packet, i.e. the source port number, and searches the first-level storage table of the source port number for a value range number corresponding to the sixth block.

For example, the source port number retrieved from the packet is 0x0200, and the network device finds that the value range number corresponding to 0x0200 in the first-level storage table of the source port number shown in Table 14 is 0.

Block 160G: The network device retrieves the seventh block from the received packet, i.e. the destination port number, and searches the first-level storage table of the destination port number for a value range number corresponding to the seventh block.

For example, the destination port number retrieved from the packet is 0x0050, and the network device finds that the value range number corresponding to 0x0050 in the first-level storage table of the destination port number shown in Table 15 is 1.

It should be noted that, in Block 103, each first-level storage table includes values from the minimum numeral 0 of a corresponding number system to the maximum numeral corresponding to the value range of a block In practical service applications, there may be no value range numbers corresponding to some value indexes in the range from the minimum numeral to the maximum numeral at all; in this case, these value indexes do not need to be recorded in the first-level storage table. However, preferably, these value indexes may be recorded in the first-level storage table and the value range numbers corresponding to these value indexes may be recorded as null. In this way, in Block 106, when a value index of one block, such as the higher 16 bits of the source IP address 0x0101, is searched for in the first-level storage table of the higher 16 bits of the source IP address, it is not needed to perform a traverse manner and a value index corresponding to the block can be found conveniently according to an ascending sequence of storage addresses of value indexes. For example, according to the difference between 0x0101 and 0x0000, 0x0101 can be directly found in the storage position which is the original address of the higher 16 bits of the source IP address plus the difference, and therefore, the search speed is increased greatly.

Block 107: According to a sequence of forming the combination indexes in the second-level storage table, the value range numbers found in turn in Block 106 are combined sequentially to form a combination value. The combination value is searched for from the combination indexes in the second-level storage table, and a matched packet rule is determined according to a packet rule number corresponding to the found combination value.

Herein, the sequence of forming the combination indexes in the second-level storage table is: the higher 16 bits of the source IP address, the lower 16 bits of the source IP address, the higher 16 bits of the destination IP address, the lower 16 bits of the destination IP address, the protocol type, the source port number and then the destination port number. According to the sequence, the value range numbers found in turn in the above 160A to 160G should be numbered in turn and the combination value 1201001 is obtained. By searching for the combination value 1201001 from the combination indexes in the second-level storage table shown in Table 18, the packet rule number such as 4 corresponding to the combination value 1201001 is obtained, and it may be therefore determined that the packet rule 4 matches the received packet.

Block 108: The packet is processed according to a processing action in the matched packet rule.

Herein, because it is determined according to the second-level storage table shown in Table 18 that the packet rule 4 matches the packet, the packet is discarded according to the processing action “Not Pass” in the packet rule 4.

In the process shown in FIG. 1, the packet rule matching is realized by two levels of the storage tables according to this embodiment of the present invention. In the practical service applications of the present application, the packet rule matching may also be realized by three or more levels of the storage tables. With respect to two levels of the storage tables, only the first-level storage table and the final-level storage table should be created; comparatively, with respect to three or more levels of the storage tables, the creation of the first-level storage table and the final-level storage table is the same as the creation of the first-level storage table and the second-level storage table in the case of two levels of the storage tables, but an intermediate-level storage table also needs to be created.

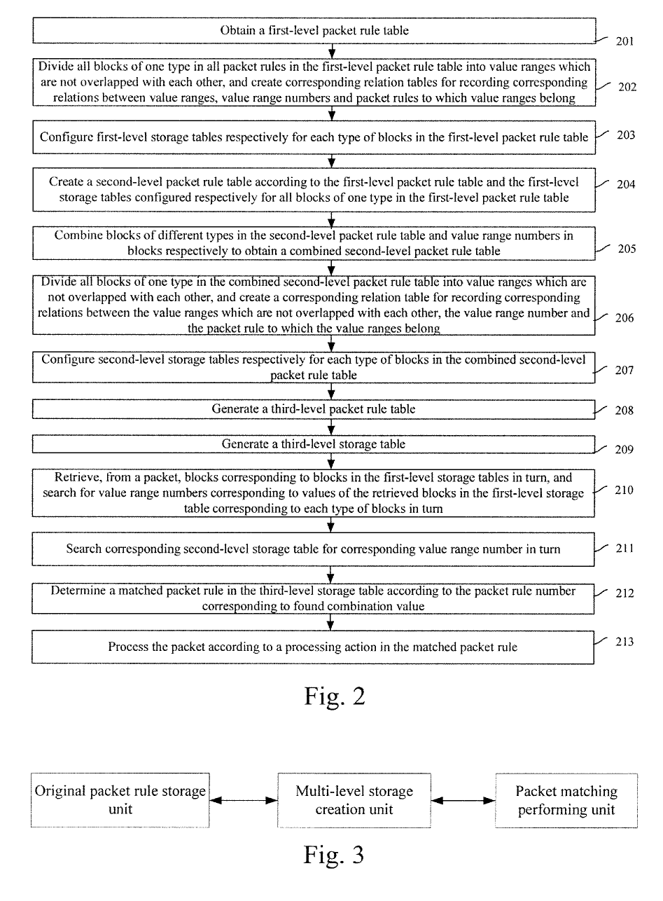

FIG. 2 is a flowchart illustrating packet rule matching in accordance with a second embodiment of the present invention. As shown in FIG. 2, in another embodiment of the present invention, the process of performing packet rule matching is described below by taking the creation of three levels of storage tables according to quintuple of packet rules as an example.

Processes in Block 201 to Block 204 are similar to processes in Block 101 to Block 104.

By far, seven first-level storage tables corresponding to each type of the blocks in the quintuple of all packet rules, such as Tables 10 to 16, are created; and one second-level packet rule table such as Table 17 is created.

Block 205: In the second-level packet rule table, blocks of different types are combined and value range numbers in the blocks of different types are also combined, and a combined second-level packet rule table is obtained.

In this process, because three levels of the storage tables need to be created, the number of storage tables from the first level to the third level is decreased in turn. In the above Block 201 to Block 204, the quintuple of each packet rule is divided into seven blocks, and therefore seven first-level storage tables are created. In order to make the number of the second-level storage tables less than seven, the number of the blocks of the quintuple of each packet rule needs to be reduced to be less than seven, and therefore, Block 205 is performed in which the blocks of different types and value range numbers in the blocks of different types are respectively combined.

A combined second-level packet rule table obtained according to the second-level packet rule table shown in Table 17 may refer to Table 19 below.

TABLE 19
Combined second-level packet rule table

| Packet | Source IP | Destination IP | | |
|---|---|---|---|---|
| rule | address | address | Protocol port | Processing |
| number | (quaternary) | (quaternary) | (quaternary) | action |
| 1 | 12 | 11, 12 | 000, 001, 100, 101 | Pass |
| 2 | 11, 12 | 11, 12 | 101 | Pass |
| 3 | 00, 01, 02 | 12 | 101 | Pass |
| | 10, 11, 12 | | | |
| 4 | 00, 01, 02 | 00, 01, 02 | 000, 001, 100, 101 | Not Pass |
| | 10, 11, 12 | 10, 11, 12 | | |

Referring to Table 17 and Table 19, the process of combining the blocks of different types and the value range numbers in the blocks of different types respectively in the second-level packet rule table shown in Table 17 includes: combining two blocks of each packet rule in the second-level packet rule table, one of which is the higher 16 bits of the source IP address and the other of which is the lower 16 bits of the source IP address; combining all value range numbers corresponding to the higher 16 bits of the source IP address with all value range numbers corresponding to the lower 16 bits of the source IP address; combining two blocks one of which is the higher 16 bits of the destination IP address and the other of which is the lower 16 bits of the destination IP address, and combining all value range numbers corresponding to the higher 16 bits of the destination IP address with all value range numbers corresponding to the lower 16 bits of the destination IP address; combining three blocks including the protocol type, the source port number and the destination port number, combining each value range number of a first block of the three blocks respectively with all value range numbers corresponding to a second block of the three blocks to obtain all combinations, and combining each value range number of a third block of the three blocks respectively with the all combinations. For example, taking the packet rule 1 in Table 17 as an example, after the value range number 1 of the higher 16 bits of the source IP address is combined with the value range number 2 of the lower 16 bits of the source IP address, the combined value range number 12 shown in Table 19 is obtained; after the value range number 1 of the higher 16 bits of the destination IP address is combined respectively with the value range numbers 1 and 2 of the lower 16 bits of the destination IP address, the combined value range numbers 11 and 12 shown in Table 19 are obtained.

Block 206: According to value ranges of all blocks of one type in the combined intermediate-level packet rule table, all the blocks of one type in the combined second-level packet rule table are divided into value ranges which are not overlapped with each other, and a corresponding relation table for recording corresponding relations between the value ranges which are not overlapped with each other, the value range number and the packet rule to which the value ranges belong is created.

The implementation manner in this Block is similar to the implementation manner of creating the corresponding relation table in Block 102 above.

Referring to the combined second-level packet rule table shown in Table 19, there are three types of blocks: the source IP address, the destination IP address and the protocol port.

The blocks of one type in the combined second-level packet rule table, i.e. the source IP addresses are described.

Because all the value range numbers in the combined second-level packet rule table shown in Table 19 are quaternary, the corresponding relation table created for all the source IP addresses may refer to Table 20 below, where the corresponding relation table records the corresponding relations between the value ranges, the value range numbers and the packet rules to which the value ranges belong.

TABLE 20
Corresponding relation table of source IP address

| Value | Value | Packet rule to which |
|---|---|---|
| range | range number | value range belongs |
| 00-02 | 0 | 3, 4 |
| 10 | 0 | 3, 4 |
| 11 | 1 | 2, 3, 4 |
| 12 | 2 | 1, 2, 3, 4 |

Referring to Table 20, because the value range 00-02 and the value range 10 correspond to the same packet rules, i.e. the packet rules 3 and 4, the same value range number is designed for the two value ranges.

The blocks of one type in the combined second-level packet rule table, i.e. destination IP addresses are described.

Similarly, because all the value range numbers in Table 19 are quaternary, the corresponding relation table created for all the destination IP addresses may refer to Table 21 below, where the corresponding relation table records the corresponding relations between the value ranges, the value range numbers and the packet rules to which the value ranges belong.

TABLE 21
Corresponding relation table of destination IP address

| Value | Value | Packet rule to which |
|---|---|---|
| range | range number | value range belongs |
| 00-02 | 0 | 4 |
| 10 | 0 | 4 |
| 11 | 1 | 1, 2, 4 |
| 12 | 2 | 1, 2, 3, 4 |

The blocks of one type in the combined second-level packet rule table, i.e. the protocol ports are described.

Similarly, because all the value range numbers in Table 19 are quaternary, the corresponding relation table created for the protocol ports may refer to Table 22 below, where the corresponding relation table records the corresponding relations between the value ranges, the value range numbers and the packet rules to which the value ranges belong.

TABLE 22
Corresponding relation table of protocol port

| Value | | Packet rule to which |
|---|---|---|
| range | Value range number | value range belongs |
| 000-001 | 0 | 1, 4 |
| 100 | 0 | 1, 4 |
| 101 | 1 | 1, 2, 3, 4 |

Block 207: According to the corresponding relation tables created respectively for all types of the blocks in the combined second-level packet rule table, second-level storage tables are configured respectively for each type of the blocks in the combined second-level packet rule table; where the corresponding relation tables record the corresponding relations between the value ranges, the value range numbers and the packet rules to which the value ranges belong.

The implementation manner in this Block is similar to that for creating the first-level storage table in Block 103 above.

In this Block, the second-level storage tables may include value indexes and value range numbers corresponding to the value indexes.

In this Block, the process of creating a second-level storage table corresponding to blocks of one type in the combined second-level packet rule table includes: taking, from the second-level storage table, all values in a value range from the minimum numeral to the maximum numeral among the blocks of one type as value indexes in turn, and determining a value range number corresponding to each value index in the second-level storage table according to the value range number corresponding to each value range in the corresponding relation table of all the blocks of one type.

The implementation of this Block will be described hereinafter with reference to specific examples.

In the combined second-level packet rule table shown in Table 19, each packet rule corresponds to three types of blocks, i.e. the source IP address, the destination IP address and the protocol port.

The corresponding relation table created for the source IP address is shown in Table 20 above, where the corresponding relation table records corresponding relations between the value ranges, the value range numbers and the packet rules to which the value ranges belong; and therefore, the second-level storage table created according to the corresponding relation table may refer to Table 23 below.

TABLE 23
Second-level storage table of source IP address

| Value index (quaternary) | Value range number |
|---|---|
| 00 | 0 |
| 01 | 0 |
| 02 | 0 |
| . . . | . . . |
| 10 | 0 |
| 11 | 1 |
| 12 | 2 |

The corresponding relation table created for the destination IP address is shown in Table 21 above, where the corresponding relation table records the corresponding relations between the value ranges, the value range numbers and the packet rules to which the value ranges belong; and therefore, the second-level storage table created according to the corresponding relation table may refer to Table 24 below.

TABLE 24
Second-level storage table of destination IP address

| Value index (quaternary) | Value range number |
|---|---|
| 00 | 0 |
| 01 | 0 |
| 02 | 0 |
| . . . | . . . |
| 10 | 0 |
| 11 | 1 |
| 12 | 2 |

The corresponding relation table created for the protocol port is shown in Table 22 above, where the corresponding relation table records the corresponding relations between the value ranges, the value range numbers and the packet rules to which the value ranges belong; and therefore, the second-level storage table created according to the corresponding relation table may refer to Table 25 below.

TABLE 25
Second-level storage table of protocol port

| Value index (quaternary) | Value range number |
|---|---|
| 000 | 0 |
| 001 | 0 |
| . . . | . . . |
| 100 | 0 |
| 101 | 1 |

As can be seen, in the flowchart of FIG. 2, the second-level storage tables are intermediate-level storage tables. The creation manner of the second-level storage tables is similar to that of the first-level storage tables, which includes: dividing blocks in a previous-level packet rule table into different types to obtain a current-level packet rule table and creating current-level storage tables corresponding to each type of the blocks in the current-level packet rule table. What is different is that: during the creation of the first-level storage table, the previous-level packet rule table of the first-level storage table is the original packet rule table, and during the creation of the second-level storage table, the combined current-level packet rule table is further created after the current-level packet rule table is created, and the current-level storage tables are created respectively for each type of blocks according to the combined current-level packet rule table.

Block 208: A third-level packet rule table is generated according to the combined second-level packet rule table and the second-level storage tables created respectively for each type of the blocks in the combined second-level packet rule table.

Herein, the process of generating the third-level packet rule table includes: replacing a value range of each block of each packet rule in the combined second-level packet rule table with a value range number corresponding to each value index in the value range in the combined second-level storage table corresponding to the type of the block.

Referring to Table 19 and Tables 23 to 25, the third-level packet rule table is shown in Table 26 below.

TABLE 26
Third-level packet rule table

| | Source | | | |
|---|---|---|---|---|
| Packet rule | IP | Destination IP | | |
| number | address | address | Protocol port | Processing action |
| 1 | 2 | 1, 2 | 0, 1 | Pass |
| 2 | 1, 2 | 1, 2 | 1 | Pass |
| 3 | 0, 1, 2 | 2 | 1 | Pass |
| 4 | 0, 1, 2 | 0, 1, 2 | 0, 1 | Not Pass |

The processing in this Block is similar to that in Block 104 above, and Table 26 may be generated according to the process of generating Table 17 in Block 104.

Block 209: A combination is formed by value range numbers of all blocks of each packet rule in the third-level packet rule table, and a third-level storage table is generated according to the combination and the packet rule number corresponding to the combination.

The third-level storage table may include a combination index and a packet rule number corresponding to the combination index.

In this Block, the process of generating the third-level storage table according to each packet rule in the third-level packet rule table includes: determining the number of bits of a combination according to the number of the blocks of each packet rule in the third-level packet rule table, taking all combination values in a range from the minimum combination numeral in the combination to the maximum combination numeral formed by the value range numbers of the blocks as combination indexes in the third-level storage table, taking a packet rule number corresponding to the combination values formed by the value range numbers of the blocks of each packet rule in the third-level packet rule table as the packet rule number corresponding to the combination indexes in the third-level storage table.

The third-level storage table generated according to the third-level packet rule table shown in Table 26 may refer to Table 27 below.

TABLE 27
Third-level storage table

| Combination index (quaternary) | Packet rule number |
|---|---|
| 000 | 4 |
| 001 | 4 |
| . . . | |
| 010 | 4 |
| 011 | 4 |
| . . . | |
| 020 | 4 |
| 021 | 3 |
| . . . | |
| 100 | 4 |
| 101 | 4 |
| . . . | |
| 110 | 4 |
| 111 | 2 |
| . . . | |
| 120 | 4 |
| 121 | 2 |
| . . . | |
| 200 | 4 |
| 201 | 4 |
| . . . | |
| 210 | 1 |
| 211 | 1 |
| . . . | |
| 220 | 1 |
| 221 | 1 |

The processing in this Block is similar to that in Block 105 above, and Table 27 may be generated according to the process of generating Table 18 in Block 105.

As can be seen, in this Block, the sequence of forming the combination indexes in the third-level storage table is: the source IP address, the destination IP address and then the protocol port.

Descriptions in Block 210 are the same as descriptions in Block 106.

Block 211: According to the manner of combining blocks of the first-level packet rule table to generate the combined second-level packet rule table, the corresponding numbers found in Block 210 are combined to form combination values, and the second-level storage tables respectively corresponding to the types of the blocks in the combined second-level packet rule table are searched in turn for value range numbers respectively corresponding to all the combination values.

Referring to the combined second-level packet rule table shown in Table 19 and the first-level packet rule table shown in Table 2, the combination manner is that: the blocks corresponding to the higher 16 bits of the source IP address are combined with the blocks corresponding to the lower 16 bits of the source IP address to form the type of the blocks of the source IP address; the blocks corresponding to the higher 16 bits of the destination IP address are combined with the blocks corresponding to the lower 16 bits of the destination IP address to form the type of the blocks of the destination IP address, and the blocks corresponding to the protocol type, the blocks corresponding to the source port number, and the blocks corresponding to the destination port number are combined to form the type of the blocks of the protocol port.

Therefore, according to the above combination manner, the value range number found in Block 210 according to the higher 16 bits of the source IP address in the packet should be combined with the value range number found in Block 210 according to the lower 16 bits of the source IP address in the packet, and the corresponding value range number, such as 1, is found in the second-level storage table corresponding to the block (i.e. the source IP address) in the combined second-level packet rule table. Then, the value range number found in Block 210 according to the higher 16 bits of the destination IP address in the packet should be combined with the value range number found in Block 210 according to the lower 16 bits of the destination IP address in the packet, and the corresponding value range number, such as 0, is found in the second-level storage table corresponding to the block (i.e. the destination IP address) in the combined second-level packet rule table. The value range numbers found respectively according to the protocol type, the source port number and the destination port number in the packet are combined, and the corresponding value range number, such as 1, is found in the second-level storage table corresponding to the corresponding block (i.e. the protocol port) in the combined second-level packet rule table.

Block 212: According to the sequence of forming the combination indexes in the third-level storage table, the value range numbers found in turn in Block 211 are combined sequentially to form a combination value, the combination value is searched for from the combination indexes in the third-level storage table, and a matched packet rule is determined according to the packet rule number corresponding to the found combination value.

Herein, the sequence of forming the combination indexes in the third-level storage table is: the source IP address, the destination IP address and then the protocol port. According to the sequence, the value range numbers respectively corresponding to the source IP address, the destination IP address and the protocol port found in Block 211 above are numbered in turn, for example forming a combination value 101, and the packet rule number 4 corresponding to 101 may be found in the combination indexes in the third-level storage table shown in Table 27. Therefore, it may be determined that the matched packet rule is the packet rule 4.

Block 213: The packet is processed according to the processing action in the matched packet rule.

As can be seen, in the embodiments of the present invention, multiple levels of the storage tables are created according to the original packet rule table, and each level of the storage tables only include the corresponding relations between the indexes and the value range numbers or between the indexes and the packet rule numbers. Thus, after the network device receives the packet, the network device only needs to search the multiple levels of the storage tables instead of searching the original packet rule table. Therefore, in the case that there are large numbers of packet rules in the original packet rule table, the time for finding a matched packet rule can be greatly reduced by searching the multiple levels of the storage tables, and the speed of the packet rule matching is increased greatly, so that the processing performance of the network device is increased.

Hereinafter, the advantages of the present invention will be explained more clearly according to a specific example.

Supposing that the original packet rule table includes ten packet rules, because each packet rule has five elements of the quintuple, the network device needs to perform matching for the five elements of each packet rule one by one upon receiving the packet, and the matching is performed 10×5=50 times. Comparatively, in the embodiments of the present invention, if two levels of the storage tables are created according to the method shown in the flowchart of FIG. 1, it is only necessary to perform the matching for seven first-level storage tables and one second-level storage table, i.e. the matching is performed eight times in total which are far less than the times for performing the matching in the prior art, and therefore, the speed of the packet rule matching is increased greatly. If three levels of the storage tables are created according to the method shown in the flowchart of FIG. 2, it is necessary to perform the matching for seven first-level storage tables, three second-level storage tables and one third-level storage table, i.e. the matching is performed eleven times in total which are also far less than the times for performing the matching in the prior art, and therefore, the speed of the packet rule matching is increased greatly.

Accordingly, the present invention further provides an apparatus for packet rule matching. FIG. 3 is a schematic diagram illustrating a structure of an apparatus for packet rule matching. As shown in FIG. 3, the apparatus includes: a multi-level storage table creation unit and a packet matching performing unit.

The multi-level storage table creation unit is adapted to create and store multiple levels of storage tables, where a storage table other than a final-level storage table records corresponding relations between value indexes and value range numbers, and the final-level storage table records corresponding relations between packet rule numbers and combination indexes formed by the value range numbers.

The packet matching performing unit is adapted to search for values of quintuple of a packet from the value indexes in first-level storage tables stored in the multi-level storage table creation unit upon receiving the packet, search next-level storage tables stored in the multi-level storage table creation unit according to value range numbers corresponding to the found value indexes until a penultimate-level storage table; search the combination indexes in a final-level storage table stored in the multi-level storage table creation unit for a combination value formed by the value range numbers found in the penultimate-level storage table, and obtain a packet rule number corresponding to the found combination value; take a packet rule corresponding to the obtained packet rule number as a matched packet rule.

The apparatus may further include an original packet rule table storage unit, adapted to store an original packet rule table.

The multi-level storage table creation unit is adapted to, when creating the first-level storage tables, divide each element of quintuple of each packet rule in the original packet rule table stored in the original packet rule table storage unit into blocks with designated bits to obtain a first-level packet rule table, divide all blocks of one type in all packet rules in the first-level packet rule table into value ranges which are not overlapped with each other according to value ranges of all the blocks of one type in all the packet rules in the first-level packet rule table, and create corresponding relation tables for recording corresponding relations between the value ranges, the value range numbers and the packet rules to which the value ranges belong; configure the first-level storage tables respectively corresponding to each type of the blocks in the first-level packet rule table according to the corresponding relation tables created above, where the first-level storage tables respectively corresponding to each type of the blocks all include corresponding relations between the value indexes and the value range numbers.

The multi-level storage table creation unit is adapted to, when dividing each element of quintuple of each packet rule into the blocks with designated bits to obtain the first-level storage tables, divide a source IP address in the quintuple of each original packet rule into two types of blocks, one being higher 16 bits of the source IP address and the other being lower 16 bits of the source IP address; divide a destination IP address into two types of blocks, one being higher 16 bits of the destination IP address and the other being lower 16 bits of the destination IP address; take a source port number as one type of blocks including 16 bits, a destination port number as one type of blocks including 16 bits and a protocol type as one type of blocks including 8 bits; and then obtain the first-level storage tables in which each packet rule corresponds to seven types of blocks.

The multi-level storage table creation unit is adapted to create three or more levels of storage tables and create each intermediate-level storage table in turn according to a sequence from a lower level to a higher level; when creating each intermediate-level storage table, replace a value range of each block in a previous-level packet rule table with a value range number corresponding to each value index in the value range in the previous-level storage table corresponding to the type of the block to generate an intermediate-level packet rule table, combine blocks of different types and value range numbers of the blocks of different types respectively in the intermediate-level packet rule table to obtain a combined intermediate-level packet rule table, divide all blocks of one type in the combined intermediate-level packet rule table into value ranges which are not overlapped with each other according to a value range of each block of one type in the combined intermediate-level packet rule table, and create corresponding relation tables for recording corresponding relations between the value ranges, the value range numbers and the packet rules to which the value ranges belong, and then, according to the corresponding relation tables created respectively, create the intermediate-level storage table corresponding to each type of the blocks in the combined intermediate-level packet rule table. The intermediate-level storage table corresponding to each type of the blocks includes the corresponding relations between the value indexes and the value range numbers.

The multi-level storage table creation unit is adapted to, when combining the blocks of different types in the second-level packet rule table and combining the value range numbers of the blocks of different types, combine two blocks of each packet rule in the second-level packet rule table together, i.e. the higher 16 bits of the source IP address and the lower 16 bits of the source IP address, and combine all value range numbers corresponding to the higher 16 bits of the source IP address with all value range numbers corresponding to the lower 16 bits of the source IP address; combine two blocks of each packet rule together, i.e. the higher 16 bits of the destination IP address and the lower 16 bits of the destination IP address, and combine all value range numbers corresponding to the higher 16 bits of the destination IP address with all value range numbers corresponding to the lower 16 bits of the destination IP address; combine three blocks including the protocol type, the source port number and the destination port number, and combine each value range number of a first block of the three blocks with each value range number of a second block of the three blocks, and then combine a value range number of a third block of the three blocks with the combination.

The multi-level storage table creation unit is adapted to, when creating a final-level storage table, replace a value range of each block in the previous-level packet rule table obtained with value range numbers respectively corresponding to all value indexes in the value range in the previous-level storage table corresponding to the type of the block to generate a final-level packet rule table, determine the number of bits of a combination according to the number of the blocks of each packet rule in the final-level packet rule table, take all combination values in a range from the minimum combination numeral to the maximum combination numeral formed by the value range numbers of the blocks as combination indexes in the third-level storage table, take the packet rule numbers corresponding to combination values formed by the value range numbers of the blocks of each packet rule in the final-level packet rule table as packet rule numbers corresponding to the combination indexes in the final-level storage table to obtain the final-level storage table.

The multi-level storage table creation unit is adapted to, when the combination values formed by the value range numbers of the blocks of each of the multiple packet rules in the final-level packet rule table are the same combination value, choose one packet rule with a highest priority level from multiple packet rules, and take the number of the chosen packet rule as a packet rule number corresponding to a combination index identical to the combination value in the final-level storage table.

The packet matching performing unit is adapted to, when searching for the values of the quintuple of the packet from the value indexes in the first-level storage table, retrieve blocks from the packet according to the divided blocks of the quintuple in the first-level storage table, and search for value range numbers respectively corresponding to the values of the retrieved blocks from the value indexes in the first-level storage table corresponding to each type of blocks.

The packet matching performing unit is adapted to, when searching each intermediate-level storage table, according to the manner of combining blocks of the previous-level packet rule table to form the combined intermediate-level packet rule table, combine corresponding numbers found in the previous-level storage table to form combination values, and search the intermediate-level storage tables respectively corresponding to the types of blocks in the combined intermediate-level packet rule table in turn for value range numbers respectively corresponding to all the combination values.

The packet matching performing unit is adapted to, when searching for the combination values formed by the value range numbers found in the penultimate-level storage tables from the combination indexes in the final-level storage table, combine the value range numbers found respectively in penultimate-level storage tables according to a sequence of forming the combination indexes in the final-level storage table to form the combination values, and search for the combination values from the combination indexes in the final-level storage table.

According to above descriptions of embodiments, those skilled in the art can clearly understand that the present invention may be implemented in a manner of using software and a universal computer device having a function of running the software, or be implemented in a manner of hardware design. However, in many situations, the former is a preferred manner. In view of this point, the essential part of the technical solution of the present invention, namely the part contributing to the prior art, may be presented in the manner of a computer software product. The computer software product is stored in a memory medium and includes several codes to make the universal hardware platform execute the method in the embodiments of the present invention.

The foregoing are only embodiments of the present invention and are not for use in limiting the present invention, any modification, equivalent replacement or improvement made under the spirit and principles of the present invention is included in the protection scope thereof.

What is claimed is:

1. A method for packet rule matching, comprising:
creating multiple levels of storage tables, wherein a storage table other than a final-level storage table records a corresponding relation between a value index and a value range number, and the final-level storage table records a corresponding relation between a packet rule number and a combination index formed by the value range number;
upon receiving a packet, searching a first-level storage table for a value index corresponding to a value of quintuple of the packet; searching a next-level storage table according to a value range number corresponding to the found value index until a penultimate-level storage table; searching a final-level storage table for a combination index identical to a combination value formed by the value range number found in the penultimate-level storage table, and obtaining a packet rule number corresponding to the found combination value; and
taking a packet rule corresponding to the obtained packet rule number as a matched packet rule.

2. The method of claim 1, wherein creating the first-level storage table comprises:
dividing each element of quintuple of each packet rule in an original packet rule table into blocks with designated bits to obtain a first-level packet rule table;
dividing all blocks of one type in all packet rules in the first-level packet rule table into value ranges which are not overlapped with each other according to value ranges of the all blocks of one type in the all packet rules in the first-level packet rule table;
creating a corresponding relation table for recording corresponding relations between the value ranges, value range numbers and packet rules to which the value ranges belong; and
configuring the first-level storage table corresponding to the all blocks of one type in the first-level packet rule table according to the created corresponding relation table, wherein the first-level storage table corresponding to the all blocks of one type includes the corresponding relation between the value index and the value range number.

3. The method of claim 2, wherein dividing each element of the quintuple of each packet rule in the original packet rule table into the blocks with the designated bits to obtain the first-level packet rule table comprises:
dividing a source IP address in the quintuple of each packet rule into two types of blocks, one being higher 16 bits of the source IP address and the other being lower 16 bits of the source IP address;
dividing a destination IP address into two types of blocks, one being higher 16 bits of the destination IP address and the other being lower 16 bits of the destination IP address;
taking a source port number as one type of blocks including 16 bits, a destination port number as one type of blocks including 16 bits and a protocol type as one type of blocks including 8 bits; and
obtaining the first-level storage table in which each packet rule corresponds to seven types of blocks.

4. The method of claim 3, wherein the multiple levels of storage tables are three or more levels of storage tables; and
each intermediate-level storage table is created in turn according to a sequence from a lower level to a higher level;
wherein the intermediate-level storage table is created by:
replacing a value range of each block in a previous-level packet rule table with a value range number corresponding to each value index in the value range in a previous-level storage table corresponding to the type of the block to generate an intermediate-level packet rule table;
combining blocks of different types in the intermediate-level packet rule table and value range numbers of the blocks of the different types respectively to obtain a combined intermediate-level packet rule table;
dividing all blocks of one type in the combined intermediate-level packet rule table into value ranges which are not overlapped with each other according to value ranges of the all blocks of one type in the combined intermediate-level packet rule table;
creating the corresponding relation table for recording the corresponding relations between the value ranges, the value range numbers and the packet rules to which the value ranges belong; and
creating the intermediate-level storage table corresponding to the all blocks of one type in the combined intermediate-level packet rule table according to the created corresponding relation table, wherein the intermediate-level storage table corresponding to the all blocks of one type includes the corresponding relation between the value index and the value range number.

5. The method of claim 4, wherein, if the intermediate-level storage table is a second-level storage table, combining the blocks of the different types in the intermediate-level packet rule table and the value range numbers of the blocks of the different types respectively comprises:
combining two blocks of each packet rule in the second-level packet rule table, wherein one block is the higher 16 bits of the source IP address and the other block is the lower 16 bits of the source IP address, and combining all value range numbers corresponding to the higher 16 bits of the source IP address with all value range numbers corresponding to the lower 16 bits of the source IP address;
combining two blocks, wherein one block is the higher 16 bits of the destination IP address and the other block is the lower 16 bits of the destination IP address, and combining all value range numbers corresponding to the higher 16 bits of the destination IP address with all value range numbers corresponding to the lower 16 bits of the destination IP address; and
combining three blocks including the protocol type, the source port number and the destination port number, combining each value range number of a first block of the three blocks and each value range number of a second block of the three blocks, and combining each value range number of a third block of the three blocks with the combinations of value range numbers corresponding to the first and second blocks of the three blocks.

6. The method of claim 2, wherein creating the final-level storage table includes:
replacing a value range of each block in the previous-level packet rule table with value range numbers respectively corresponding to all value indexes in the value range in the previous-level storage table corresponding to the type of the block to generate a final-level packet rule table;
determining the number of bits of a combination according to the number of blocks of each packet rule in the final-level packet rule table;
taking all combination values in a range from a minimum combination numeral in the combination to a maximum combination numeral formed by the value range numbers of the blocks as combination indexes in the final-level storage table; and
taking a packet rule number corresponding to a combination value formed by the value range numbers of the blocks of each packet rule in the final-level packet rule table as a packet rule number corresponding to a combination index in the final-level storage table to obtain the final-level storage table.

7. The method of claim 6, further comprising:
if the combination values formed by the value range numbers of the blocks of each of multiple packet rules in the final-level packet rule table are a same combination value,
choosing one packet rule with a highest priority level from the multiple packet rules, and
taking a number of the chosen packet rule as a packet rule number corresponding to a combination index identical to the combination value in the final-level storage table.

8. The method of claim 2, wherein searching the first-level storage table for the value index corresponding to the value of the quintuple of the packet comprises:
retrieving a block from the packet according to the divided blocks of the quintuple in the first-level storage table, and
searching the first-level storage table corresponding to each type of blocks in turn for a value range number corresponding to the value index of the retrieved block.

9. The method of claim 4, wherein searching each intermediate-level storage table comprises:
according to a manner of combining blocks of the previous-level packet rule table to form the combined intermediate-level packet rule table, combining corresponding numbers found in the previous-level storage table to form combination values, and
searching the intermediate-level storage table corresponding to each type of the blocks in the combined intermediate-level packet rule table for value range numbers respectively corresponding to the combination values.

10. The method of claim 6, wherein searching the final-level storage table for the combination index identical to the combination value formed by the value range numbers found in the penultimate-level storage table comprises:
combining value range numbers found in each penultimate-level storage table sequentially according to a sequence of forming the combination indexes in the final-level storage table to form the combination value; and
searching the final-level storage table for the combination index identical to the combination value.

11. An apparatus for packet rule matching, comprising:
a multi-level storage table creation unit, adapted to create and store multiple levels of storage tables, wherein a storage table other than a final-level storage table records a corresponding relation between a value index and a value range number, and the final-level storage table records a corresponding relation between a packet rule number and a combination index formed by the value range number;
a packet matching performing unit, adapted to search a first-level storage table stored in the multi-level storage table creation unit for a value index corresponding to a value of quintuple of a packet upon receiving the packet, search a next-level storage table stored in the multi-level storage table creation unit according to a value range number corresponding to the found value index until a penultimate-level storage table; search a final-level storage table stored in the multi-level storage table creation unit for a combination index identical to a combination value formed by the value range number found in the penultimate-level storage table, and obtain a packet rule number corresponding to the found combination value; take a packet rule corresponding to the obtained packet rule number as a matched packet rule.

12. The apparatus of claim 11, further comprising:
an original packet rule table storage unit, adapted to store an original packet rule table; wherein
the multi-level storage table creation unit is adapted to, when creating the first-level storage table, divide each element of quintuple of each packet rule in the original packet rule table in the original packet rule table storage unit into blocks with designated bits to obtain a first-level packet rule table, divide all blocks of one type in all packet rules in the first-level packet rule table into value ranges which are not overlapped with each other according to value ranges of the all blocks of one type in the all packet rules in the first-level packet rule table, and create a corresponding relation table for recording corresponding relations between the value ranges, value range numbers and packet rules to which the value ranges belong; configure the first-level storage table corresponding to the all blocks of one type in the first-level packet rule table according to the created corresponding relation table, wherein the first-level storage table corresponding to the all blocks of one type includes the corresponding relation between the value index and the value range number.

13. The apparatus of claim 12, wherein the multi-level storage table creation unit is adapted to, when dividing each element of quintuple of each packet rule into the blocks with the designated bits to obtain the first-level storage table, divide a source IP address in the quintuple of each packet rule into two types of blocks, one being higher 16 bits of the source IP address and the other being lower 16 bits of the source IP address; divide a destination IP address into two types of blocks, one being higher 16 bits of the destination IP address and the other being lower 16 bits of the destination IP address; take a source port number as one type of blocks including 16 bits, a destination port number as one type of blocks including 16 bits and a protocol type as one type of blocks including 8 bits; and obtain the first-level storage table in which each packet rule corresponds to seven types of blocks.

14. The apparatus of claim 13, wherein the multi-level storage table creation unit is adapted to create three or more levels of storage tables, and create each intermediate-level storage table in turn according to a sequence from a lower level to a higher level through:
replace a value range of each block in a previous-level packet rule table with a value range number corresponding to each value index in the value range in a previous-level storage table corresponding to the type of the block to generate an intermediate-level packet rule table,
combine blocks of different types in the intermediate-level packet rule table and value range numbers of the blocks of different types respectively to obtain a combined intermediate-level packet rule table,
divide all blocks of one type in the combined intermediate-level packet rule table into value ranges which are not overlapped with each other according to value ranges of the all blocks of one type in the combined intermediate-level packet rule table, and
create the corresponding relation table for recording the corresponding relations between the value ranges, the value range numbers and the packet rules to which the value ranges belong, and
create the intermediate-level storage table corresponding to the all blocks of one type in the combined intermediate-level packet rule table according to the created corresponding relation table, wherein the intermediate-level storage table corresponding to the all blocks of one type includes the corresponding relation between the value index and the value range number.

15. The apparatus of claim 14, wherein the multi-level storage table creation unit is adapted to, when combining the blocks of different types in a second-level packet rule table and combining value range numbers of the blocks of the different types, combine two blocks of each packet rule in the second-level packet rule table, wherein one block is the higher 16 bits of the source IP address and the other block is the lower 16 bits of the source IP address, and combine all value range numbers corresponding to the higher 16 bits of the source IP address with all value range numbers corresponding to the lower 16 bits of the source IP address; combine two blocks of each packet rule, wherein one block is the higher 16 bits of the destination IP address and the other block is the lower 16 bits of the destination IP address, and combine all value range numbers corresponding to the higher 16 bits of the destination IP address with all value range numbers corresponding to the lower 16 bits of the destination IP address; combine three blocks including the protocol type, the source port number and the destination port number, combine each value range number of a first block of the three blocks and each value range number of a second block of the three blocks, and combine each value range number of a third block of the three blocks with the combinations of value range numbers corresponding to the first and second blocks of the three blocks.

16. The apparatus of claim 12, wherein the multi-level storage table creation unit is adapted to, when creating the final-level storage table, replace a value range of each block in the previous-level packet rule table with value range numbers respectively corresponding to all value indexes in the value range in the previous-level storage table corresponding to the type of the block to generate a final-level packet rule table; determine the number of bits of a combination according to the number of blocks of each packet rule in the final-level packet rule table; take all combination values in a range from a minimum combination numeral in the combination to a maximum combination numeral formed by the value range numbers of the blocks as combination indexes in the final-level storage table; take a packet rule number corresponding to a combination value formed by the value range numbers of the blocks of each packet rule in the final-level packet rule table as a packet rule number corresponding to a combination index in the final-level storage table to obtain the final-level storage table.

17. The apparatus of claim 16, wherein the multi-level storage table creation unit is adapted to, if the combination values formed by the value range numbers of the blocks of each of multiple packet rules in the final-level packet rule table are a same combination value, choose one packet rule with a highest priority level from the multiple packet rules, and take a number of the chosen packet rule as a packet rule number corresponding to a combination index identical to the combination value in the final-level storage table.

18. The apparatus of claim 12, wherein the packet matching performing unit is adapted to, when searching the first-level storage table for the value index corresponding to the value of the quintuple of the packet,
retrieve a block from the packet according to the divided blocks of the quintuple in the first-level storage table, and
searching the first-level storage table corresponding to each type of blocks in turn for a value range number corresponding to the value index of the retrieved block.

19. The apparatus of claim 14, wherein the packet matching performing unit is adapted to, when searching each intermediate-level storage table, combine corresponding numbers found in the previous-level storage table to form combination values according to a manner of combining blocks of the previous-level packet rule table to form the combined intermediate-level packet rule table, and
search the intermediate-level storage table corresponding to each type of the blocks in the combined intermediate-level packet rule table for value range numbers respectively corresponding to the combination values.

20. The apparatus of claim 16, wherein the packet matching performing unit is adapted to, when searching the final-level storage table for the combination index identical to the combination value formed by the value range number found in the penultimate-level storage table,
combine value range numbers found in each penultimate-level storage table sequentially according to a sequence of forming the combination indexes in the final-level storage table to form the combination value; and
search the final-level storage table for the combination index identical to the combination value.

21. A method for packet rule matching, comprising:
receiving a packet from a network and determining one or more value indexes of one or more blocks of the packet; wherein a same value index is assigned to different values if the different values of a block correspond a common matching result or a common set matching results;
searching a matching table to get a matching result, wherein the matching table comprise at least one value index of at least one block and corresponding matching result.

22. The method of claim 21, wherein the one or more blocks of the packet is a part of a header of the packet.

23. The method of claim 21, wherein one or more value indexes are a plurality of value indexes of IP addresses, ports and protocol type of the packet.
